(19) United States
(12) Patent Application Publication
(10) Pub. No.: US 2007/0176902 A1
(43) Pub. Date: Aug. 2, 2007

(54) Providing input data

(76) Inventors: Andrew Newman, Enfield (GB); Tania Jane Beagley, Clapham (GB); Stuart Mark Walkington, Hemel Hempstead (GB)

Correspondence Address: HARNESS, DICKEY, & PIERCE, P.L.C, 7700 BONHOMME, STE 400, ST. LOUIS, MO, 63105, US

(21) Appl. No.: 11/638,328

(22) Filed: Dec. 13, 2006

Related U.S. Application Data
(63) Continuation-in-part of application No. 11/355,228, filed on Feb. 15, 2006.

(30) Foreign Application Priority Data
Feb. 17, 2005 (GB) 05 03 291.7

(51) Int. Cl. G09G 5/00

(52) U.S. Cl. 345/168

(57) ABSTRACT

Apparatus for covering a portable computer of the type provided with a touch screen as an alternative to a keyboard. A case generally includes a first part connected to a second part by an axial hinge. The axial hinge allows the first part and the second part to be configurable between an open position for receiving the portable computer and a closed position. The case includes a fabric keyboard sensitive to the manual application of pressure, and having defined key positions. The case also includes a control circuit for identifying mechanical interactions to generate output data. The fabric keyboard is connected to the case such that the fabric keyboard may be turned about an axis within the case that extends substantially parallel to the axis of the hinge. The portable computer includes an interface and executable instructions for interpreting the output data. The interface may be a mechanical interface or a radio interface.

### CROSS-REFERENCE TO RELATED APPLICATIONS

This application is filed as a continuation-in-part of U.S. patent application Ser. No. 11/355,228 filed 15 Feb. 2006, which in turn claims priority from United Kingdom Patent Application No. 05 03 291.7 filed 17 Feb. 2005. The disclosures of the above applications are incorporated herein by reference in its entirety as if fully set forth herein.

### FIELD

The present invention relates to apparatus for providing data input, comprising a case for receiving a portable computer, a fabric surface sensitive to the manual application of pressure and a control circuit for identifying mechanical interactions to generate output data.

### BACKGROUND

The statements in this section merely provide background information related to the present disclosure and may not constitute prior art.

Data input devices are used with data processing devices. For example, a portable computer may include a keyboard for inputting data into the portable computer.

### SUMMARY

According to an aspect of the present invention, there is provided apparatus for covering a portable computer. The apparatus generally includes a case having a first part connected to a second part by an axial hinge. The axial hinge allows the first part and the second part to be configurable between an open position for receiving the portable computer and a closed position. The case also includes a fabric keyboard sensitive to the manual application of pressure and having defined key positions. The case further includes a control circuit for identifying mechanical interactions to generate output data. The case is configured to enclose the portable computer and the fabric keyboard when in the closed position. The fabric keyboard is connected to the case such that the fabric keyboard may be turned about an axis within the case that extends substantially parallel to the axis of the hinge. The portable computer includes an interface and executable instructions for interpreting the output data.

The connection interface may be a mechanical interface or a radio interface.

The portable computer may be a tablet PC of the type that is smaller than a notebook PC but larger than a personal organizer.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 shows a manually operable fabric keyboard;

FIG. 2 shows the inner workings of the fabric keyboard shown in FIG. 1;

FIG. 3 shows details of an electronic processing device of the type shown in FIG. 2;

FIG. 4 shows a protective covering for a data processing device, in the form of a case;

FIG. 5 shows the case of FIG. 4 in an open position;

FIG. 6 shows a portable computer, in use;

FIG. 7 illustrates the use of the case of FIGS. 4 and 5, to generate input data for the operation of the portable computer of FIG. 6;

FIG. 8 illustrates a radio environment;

FIG. 9 illustrates the use the case of FIGS. 4 to 6, to generate input data for the operation of the portable computer of FIG. 6;

FIG. 10 is a rear view of the case of FIGS. 4 to 6 and 9 in an open position;

FIG. 11 is a side view of the case of FIGS. 4 to 6, 9, and 10;

FIG. 12 illustrates the use of the case of FIGS. 4 to 6 and 9 to 10 to generate input data for the operation of a received portable computer.

### DETAILED DESCRIPTION

The following description is merely exemplary in nature and is in no way intended to limit the present disclosure, application, or uses.

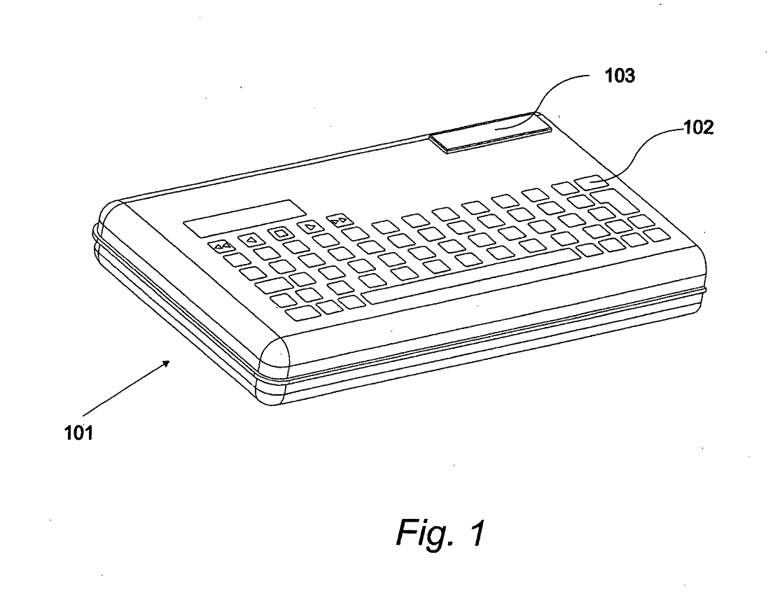

FIG. 1 illustrates a manually operable data input device embodied as a fabric keyboard. Flexible fabric keyboards are known, as illustrated in U.S. Pat. No. 6,861,961, assigned to the present assignee. The keyboard 101 is constructed substantially from fabric and has identified key positions 102, which may be printed thereon. An electronic interface device 103 identifies positions at which keys have been depressed and from this produces output data. Output data from the fabric keyboard may then be supplied as to a data processing device, such as a portable computer.

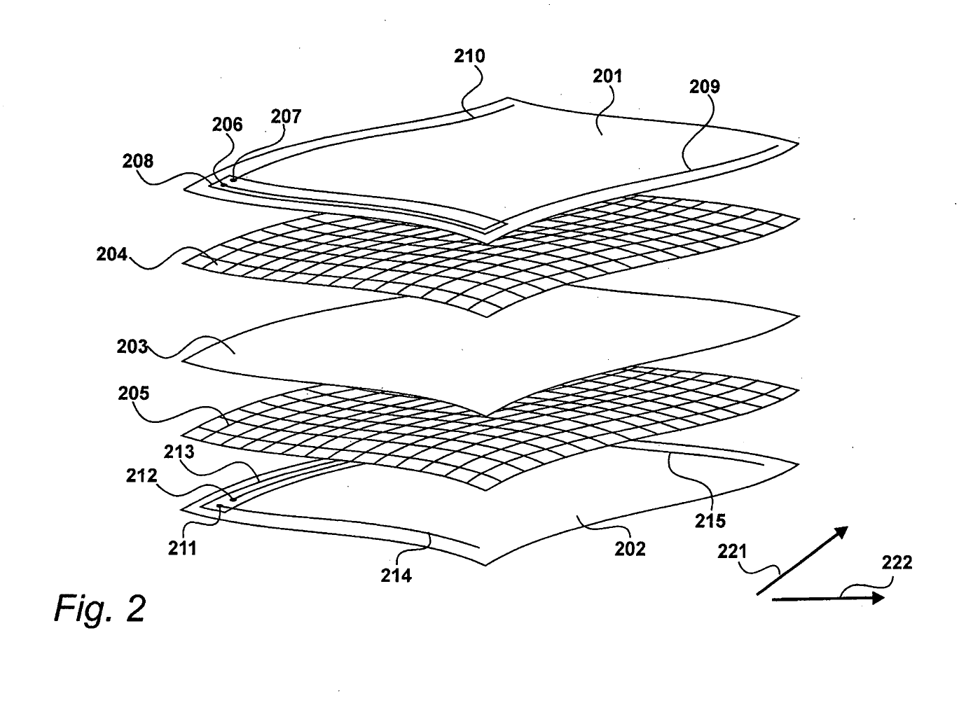

Inner workings of a fabric keyboard illustrated in FIG. 1 are shown in FIG. 2. The data input device utilizes a first fabric layer 201, a second fabric layer 202, and an intermediate fabric layer 203 disposed between the first and second fabric layers 201, 202. Each of the fabric layers 201 to 203 is electrically conductive, which is established by combining insulating fibers with electrically conducting fibers or elements. A first insulating separating layer 204 is disposed between the upper fabric layer 201 and the intermediate layer 203. A second insulating separating layer 205 is disposed between the second fabric layer 202 and the intermediate conductive layer 203. As shown in FIG. 2, the first and second insulating separating layers 204, 205 take the form of a mesh.

The first separating layer 204 is configured to separate the upper conductive fabric layer 201 and intermediate conductive fabric layer 203 in the absence of a mechanical interaction with the data input device. But the first separating layer 204 is penetrable by the upper conductive fabric layer 201 during a mechanical interaction, to thereby allow the upper conductive fabric layer 201 to make electrical contact with the intermediate conductive fabric layer 203.

Similarly, the second separating layer 205 is configured to separate the lower conductive fabric layer 202 and intermediate conductive fabric layer 203 in the absence of a mechanical interaction with the data input device. But the second separating layer 204 is penetrable by the lower conductive fabric layer 202 during a mechanical interaction, to thereby allow the lower conductive fabric layer 202 to make electrical contact with the intermediate conductive fabric layer 203. Through the intermediate conductive fabric layer 203, a conductive path between the first and second conductive fabric layers 201, 202 can be established at the position of a mechanical interaction with the data input device. The conductive fabric layers may have a weave, knit, or felt construction.

Two electrical connectors 206 and 207 are located on a rectangular insulating stripe 208 that is positioned along one edge of upper fabric layer 201. The insulating stripe 208 may be produced by printing insulating ink onto the fabric or by applying insulating adhesive tape. The connectors 206 and 207 provide a means of connecting the electronic processing device 103 to lower resistance elements 209 and 210, respectively. The lower resistance elements 209 and 210 are fabricated from fabric coated with metal, such as nickel, silver, alloys, etc. The lower resistance elements 209 and 210 are attached to the conductive fiber layers and the insulating strips by conductive adhesive, such as a pressure sensitive acrylic adhesive containing metallized particles, etc.

The lower fabric layer 202 has a similar construction to the upper fabric layer 201, having connectors 211 and 212 located on an insulating stripe 213. The connectors 211 and 212 provide means for connecting the electronic processing device 103 with low resistance elements 214 and 215, respectively. The lower resistance elements 209 and 210 of upper fabric layer 201 extend along a pair of opposed edges of the fabric layer 201. Similarly, lower resistance elements 211 and 212 of lower fabric layer 202 extend along a pair of opposed edges of the fabric layer 202.

The upper conductive fabric layer 201 includes conductive fibers arranged such that the first conductive layer 201 is conductive in a first direction 221, along the layer. The second conductive fabric layer 202 also includes conductive fibers arranged such that the second conductive layer 202 is conductive in a second direction 222, along the layer 202. In the exemplary arrangement shown, the first and second directions 221, 222 are substantially perpendicular. Thus, lower resistance elements 209 and 210 are positioned at opposed ends of a conductive path extending in the first direction 221. Similarly, lower resistance elements 211 and 212 are positioned at opposed ends of a conductive path extending in the second direction 222.

The electronic processing device 103 is arranged to apply voltages to and take measurements from the data input device. When a voltage is applied across the lower resistance elements 209 and 210, a voltage gradient is established across the first conductive fabric layer 201. When a mechanical interaction takes place, the layers are compressed and a conductive path is established between the first conductive fabric layer 201 and the second conductive fabric layer 202. The actual voltage applied to the second conductive fabric layer 202 will depend upon the position of the mechanical interaction along the first conductive path. This voltage can be measured to provide a first positional coordinate of the mechanical interaction. Hence, a potential divider is created and it is possible to determine a position of the interaction in the direction of arrow 221.

Similarly, when a voltage is applied across lower resistance elements 211 and 212, a voltage gradient appears across the second conductive fabric layer 202. When a mechanical interaction takes place, a conductive path is established between the second conductive fabric layer 202 and the first conductive fabric layer 201. The actual voltage applied to the first conductive fabric layer 201 will depend upon the position of the mechanical interaction along the second conductive path. This voltage can be measured to provide a second positional coordinate of the mechanical interaction. A potential divider is hence created and it is possible to determine a position of the interaction in the direction of arrow 222.

With reference to these two voltage measurements, it is possible to identify X-axis and/or Y-axis coordinates of a mechanical interaction within a sensing area. Thus, these two positions then define the position of the interaction on the two-dimensional plane of the keyboard, from which it is possible to identify the specific key that has been pressed. WO 00/72239 A1 discloses a sensor and suitable control circuit operations for determining characteristics of mechanical interactions with the sensor; the entire disclosure of which is incorporated herein by reference in its entirety. WO 00/72239 A1 discloses a sensor for determining x and y coordinate data, along with z data relating to pressure. WO 00/72239 A1 discloses a sensor for detecting force and area of a mechanical interaction separately, along with x and y coordinates of the mechanical interaction.

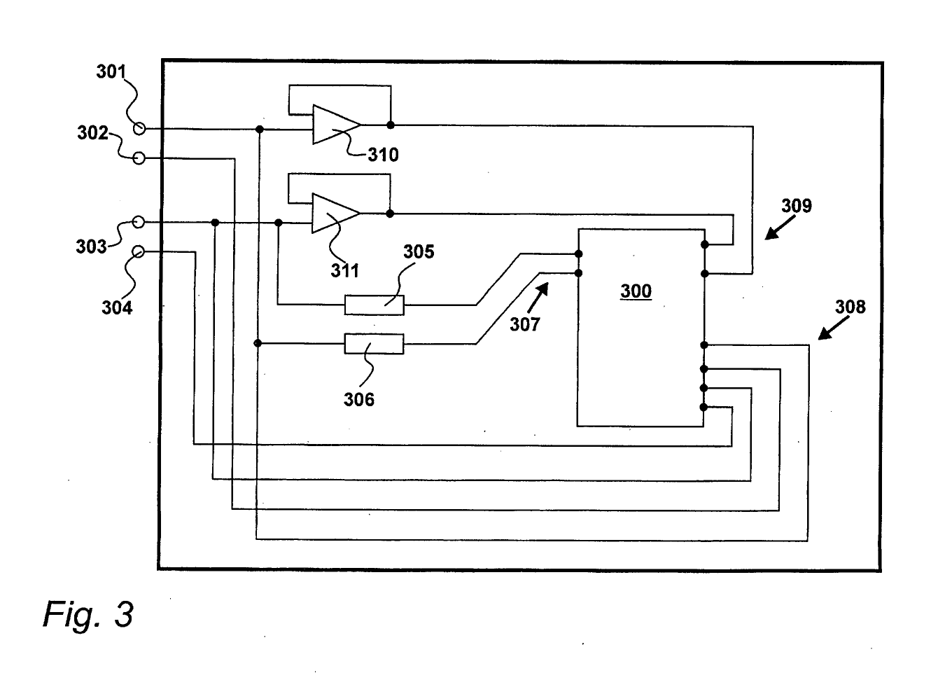

Electronic processing device 103 is detailed in FIG. 3. The processing device includes a microcontroller 300. The processing device supplies voltages to connectors 301, 302, 303, and 304 and provides output values for transmission. Resistors 305 and 306 have a resistance that is substantially similar to the resistance of the fabric detector measured from a first outer conducting layer 201 to the other outer conducting layer 202 when a typical target pressure has been applied. Values in the region of 10 k ohm are typical for these resistors.

A detection process is controlled by a program executed by the microcontroller that is, in turn, configured to supply output voltages at pins 307 and 308 and to receive analogue voltages at pins 309. Input pins 309 receive outputs from high impedance buffers 310 and 311, typically being operational amplifiers of type TL062 operating at half unity gain to provide a high impedance buffer between the output voltages and the microcontroller input ports.

The data input device may be configured to supply input data to a data processing device in accordance with a radio transmission protocol, such as a ZigBee protocol (an implementation of the IEEE 802.15.4 protocol), Bluetooth, or other appropriately configured radio transmission protocol. The electronic processing device may therefore include a low power consumption radio transmitting device interfaced so as to transmit input data received in response to key presses. The radio transmitting device is accordingly arranged to transmit radio signals to a radio receiving device arranged to receive the transmitted input data.

The processing device may hence include a wireless microcontroller. This may be an IEEE 802.15.4 wireless controller, such as the JN5121 produced by Jennic of Furnival Street, Sheffield, United Kingdom. The microcontroller may be a low power IEEE 802.15.4 compliant wireless microcontroller combining an on chip 23 bit RISC core and a fully compliant 2.4 gigahertz IEEE 802.15.4 transceiver, along with 64 kilobytes of ROM and 96 kilobytes of RAM.

The data input device may be enabled to supply input data to a data processing device by means of a mechanical interface, such as a USB computer interface.

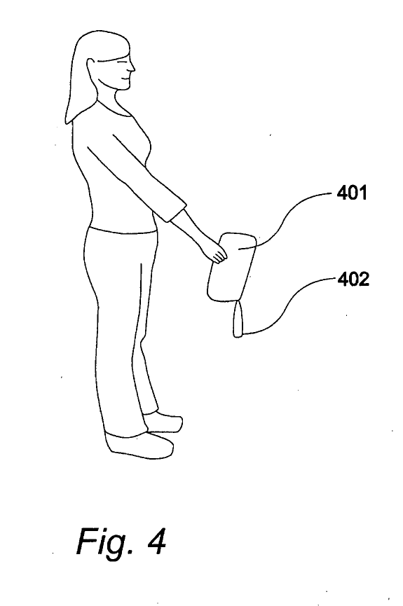

FIG. 4 shows a protective covering for a data processing device, in the form of a rectangular case 401, which is configurable between an open position for receiving the data processing device and a closed position. The case 401 may be carried in a single hand, as shown. Optionally, the case 401 may include carrying means, such as carrying strap 402 to facilitate carrying.

The protective covering is configured to prevent scratching of the outer surfaces of the data processing device and, in addition, is configured to prevent impacts adversely affecting the structural integrity of the portable device. As will be described below in further detail, the case 401 includes a manually operable data input device.

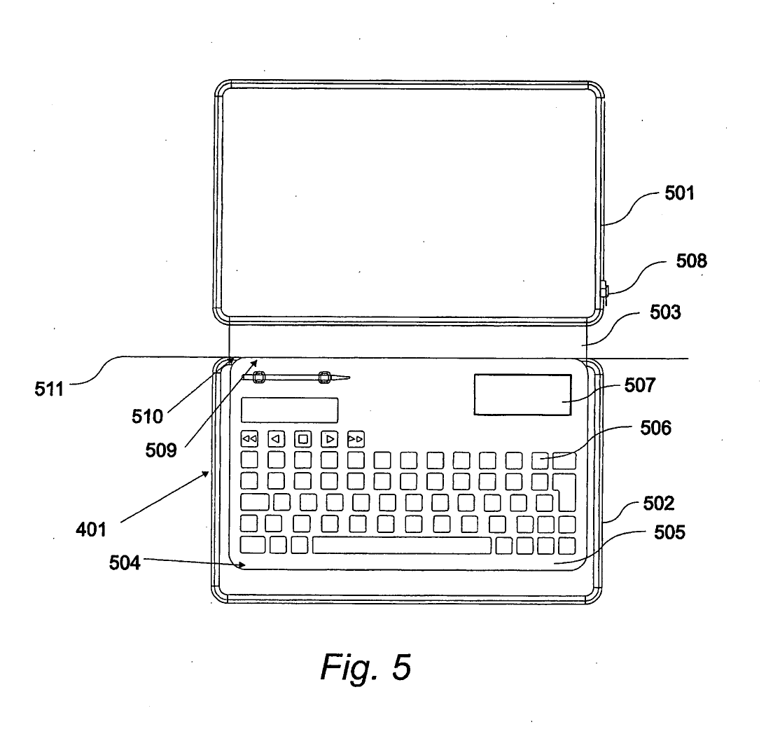

FIG. 5 shows case 401 in an open position. The case 401 includes a first part 501 and a second part 502 that are connected by an axial hinge 503. This arrangement allows the first part 501 and the second part 502 to be configurable between an open position (FIG. 5) and a closed position. The case 401 may therefore be considered as having a clamshell based design. The first part 501 and the second part 502 may have the same or different dimensions.

Preferably, the first and second parts 501, 502 of the case 401 each have a construction that incorporates sufficient set to maintain a three-dimensional shape. Hence, first and second parts 501, 502 are referred to herein as having a set shape. Preferably, each of the first and second parts 501, 502 allows a degree of flexibility. Thus, the first and second parts 501, 502 may be flexed from the initial set shape but are biased towards maintaining their set shape. In alternative arrangements, one or both of the first and second parts 501, 502 of case 401 are rigid, and thus arranged to inhibit flexing from a set shape.

The first and second parts 501, 502 may be fabricated from a plastic material. In this example, the first and second parts 501, 502 are molded Ethyl Vinyl Acetate (EVA). In the present example, hinge 503 is a fabric hinge.

The case 401 presents a fabric surface 504 that is sensitive to the manual application of pressure. The case 401 includes a manually operable data input device in the form of a keyboard 505 that is sensitive to the manual application of pressure. In this example, the keyboard 505 is a flexible, fabric keyboard such as described with reference to FIGS. 1 to 3 above, including the pressure sensitive fabric surface 504. Key positions, such as position 506, are visibly defined on the fabric surface 504. The case 401 includes a control circuit, indicated at 507, for identifying mechanical interactions and generating output data in response. The control circuit may include a housing, which, for example, may be attached to fabric surface 504 of the fabric keyboard 505.

Once open, the case 401 may receive a data processing device that includes an interface and executable instructions for interpreting output data generated by the manually operable data input device. In the closed position, the case 401 is configured to enclose both the received portable computer and the fabric keyboard 505. In this example, the case 401 includes a zip fastener 508 distributed about the free edges of the case 401 for securing the case 401 in the closed position.

The fabric keyboard 505 is connected to the case 401. As will be described in further detail below, the fabric keyboard 505 is connected to the case 401 such that it may be turned about an axis within the case 401 that extends substantially parallel to the axis of hinge 503. In this example, an inner edge 509 of the fabric keyboard 504 is connected to the case 401 in proximity to the inner edge 510 of the second part 503 of the case 401.

According to the arrangement illustrated in FIG. 5, the fabric keyboard 504 is received in the second part 502 with the outer surface 506 of fabric keyboard 504 facing upwards from the second part 502. Fabric keyboard 504 is connected to the case 401 such that the fabric keyboard 504 may be folded over the connected edge 509, turned about an axis 511, such that the outer surface 506 faces downwards towards the first part 501. This arrangement may be considered to be similar to that of a book, with the first and second parts 501, 502 representing front and back covers of a book, the hinge 503 representing the spine of the book, and the fabric keyboard 505 representing a page within the book.

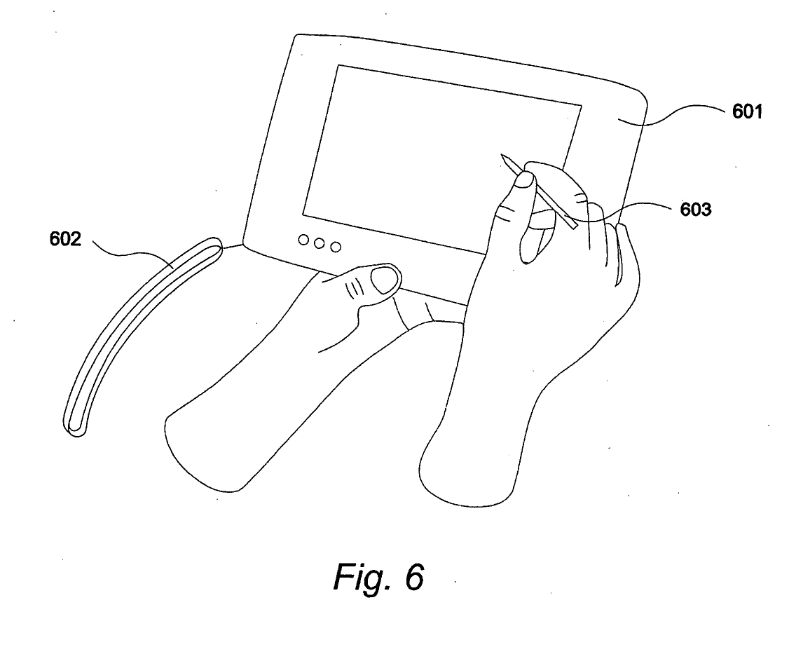

FIG. 6 shows a portable computer. In this example, portable computer 601 is of the type provided with a touch screen as an alternative to a keyboard. The touch screen of portable computer 601 is sensitive to the manual application of pressure. As shown, pressure may be applied by the manual operation of a stylus 603 or similar implement, or by direct application of a finger. The portable computer 601 may include carrying means, such as carrying strap 602 to facilitate carrying.

In this example, the portable computer is an ultra mobile PC, of the type that is smaller than a notebook PC but is larger than a personal organizer. In this example, the portable computer is a tablet PC available under the designation Samsung model NP-Q1.

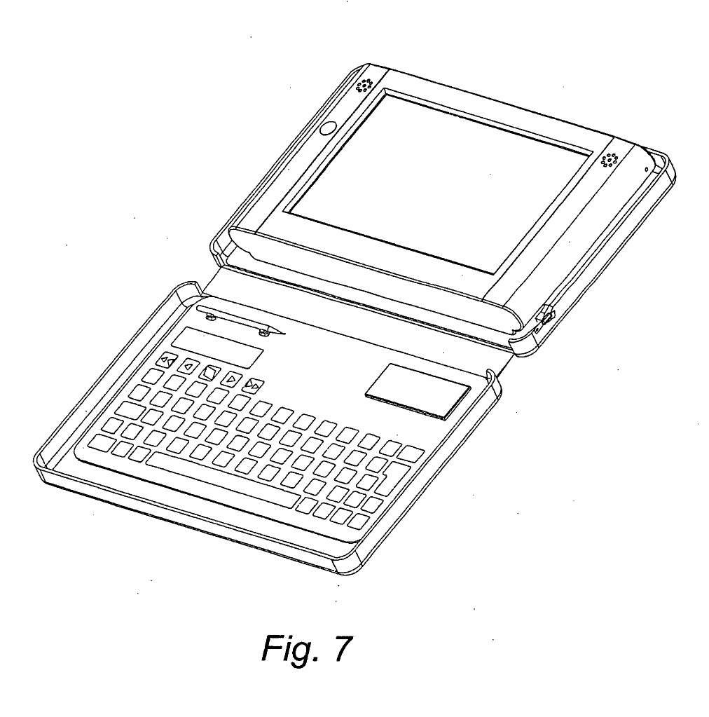

FIG. 7 illustrates the use of case 401 to generate input data for the operation of portable computer 601, which is shown received in the first part 501 of case 401. Full access to ports of the portable computer 601 may be maintained whilst the portable computer 601 is held within the case 401.

According to the arrangement illustrated in FIG. 7, both the first part 501 and the second part 502 of the case 401 are resting upon a planar support surface. Manual presses at key regions defined on the pressure sensitive fabric surface 504 of fabric keyboard 505 result in the generation of output data. The portable computer 601 includes an interface and executable instructions for interpreting the output data. Thus, portable computer 601 is programmed so as to respond to input data commands.

Output data generated in response to manual pressure applied to the fabric keyboard 505 of case 401 may result in a variety of different operations performed by the portable computer 601 in response to input data commands. For example, input data commands may be used to control an executable program, to navigate a menu, to generate text data for visual display, to construct email or text messages, to select a media item for display and/or to perform editing operations, etc.

The inclusion of a manually operable data input device in the protective case provides a convenient method of supplying input data to the portable computer. Although the portable computer may include software to present a visual keyboard that is responsive to pressure applied to the touch screen, the virtual keyboard may be so small that it is impractical for users that have impaired vision or dexterity. In addition, an on-screen keyboard may overlie or trigger a reduction in size of a graphical user interface and hence undesirably obscure graphics of interest to the user.

In this example, output data is transmitted from the case 401 to the portable computer 601 in accordance with a ZigBee radio transmission protocol. Thus, the case is provided with a radio transmitting device and the portable computer is provided with a radio interface and a radio receiving device.

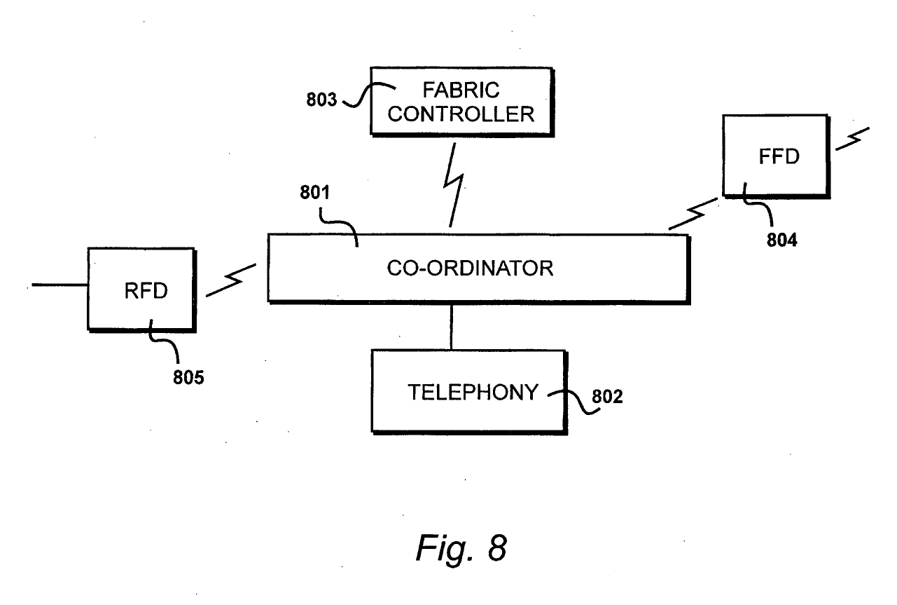

An IEEE 802.15.14 ZigBee environment is illustrated in FIG. 8. At the heart of the network, there is provided a ZigBee coordinator 801, which, in turn, operates under the control of a local computer system for performing data processing operations. The co-ordinator provides a bridge to other networks, such as a telephony network 802, etc. It is also the place where information about the network itself is stored.

The manually operable fabric controller of the case 401 illustrated in FIGS. 5 and 7 is shown as 803 in FIG. 8 and communicates wirelessly with the coordinator 801. A full function device (FFD) 804 may act as an intermediate router and allows data to be passed from other devices. A reduced function device (RFD) 805 may also be provided within the network.

The ZigBee network uses the IEEE 802.15.4 low rate wireless personal area network standard to describe its lower protocol layers, namely the physical layer and the medium access control portion of the data link layer. In this exemplary embodiment, wireless operation takes place at 2.4 gigahertz using DSSS, which is managed by the digital stream into the modulator. An orthogonal signalling scheme is used that transmits four bits per symbol in the 2.4 gigahertz band to provide a raw over-the-air data rate of 250 kilobytes per channel in the 2.4 gigahertz band. Transmission range is typically between 10 meters and 75 meters. The channel mode access specified by IEEE 802.15.4 is carrier sense, multiple access such that nodes briefly check to see that no one else is transmitting before they themselves start transmitting.

The coordinator 801 is a data processing device configured to produce an output signal. Thus, an output signal may be provided to an application program executed by a local computing facility such that data is received within an operational package, such as, for example, a spreadsheet or an email program, etc. Alternatively, the data processing device may produce an output signal to a wider network, such as that provided by the telephony functionality 802, etc.

The IEEE 802.15.14 radio environment and specifically when using the ZigBee protocol provides a low power consumption radio transmitting device that is interfaced to an input device for transmitting input data.

In relation to the example illustrated in FIGS. 4, 5 and 7, the case includes the fabric controller 803 and is interfaced to an appropriate node such as a full function device (FFD) of the type shown at 804. The portable computer includes the coordinator 801 where there is provided a radio receiving device for receiving the transmitted input data, such that the portable computer is interfaced with a radio receiving device.

A manually operable data input device constructed from fabric is configured to receive input data from a user. In the example described so far, the input device takes the form of an alphanumeric keyboard. But it should be appreciated that other input devices may be used, such as an alpha pad, a numeric keypad, an audio player controller, a combination of different regions providing different functions, etc.

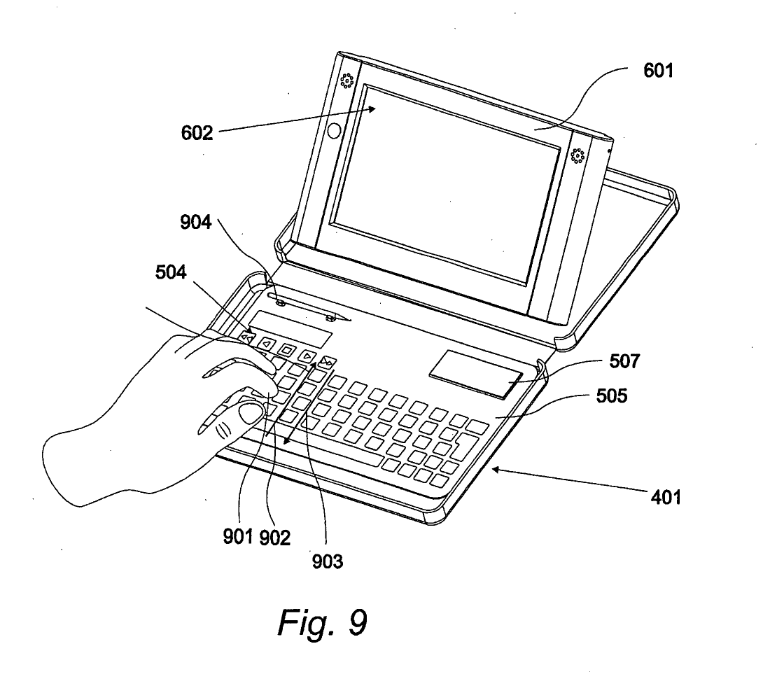

FIG. 9 shows a similar arrangement to that shown in FIG. 8. But in the example shown in FIG. 9, the portable computer 601 is shown supported at an angle to the case 401 by stand means provided therewith. Thus, touch screen of portable computer 601 is inclined relative to the keyboard 505. This arrangement may be desirable for a user of the portable computer 601, to increase the visibility of the touch screen.

The control circuit 507 of case 401 may be configured to detect the position of a mechanical interaction on fabric keyboard 505 and to detect the degree of applied pressure. The pressure sensitive fabric surface 504 of fabric keyboard 505 is sensitive to manual presses and to manually applied gesticular movements, including stroke actions, swipe actions, tapping actions and scrolling actions. Both of these types of mechanical interaction may be used to control operations of a portable computer.

For example, stroking operations across fabric surface 504 may be used to effect menu scrolling. A finger 901 may effect a stroking operation in the direction of arrow 902 to scroll up a list displayed by the portable computer. Thus, the finger 901 is applied to the fabric surface 504 and stroked in an upward direction. That is to say, movement of the finger 901 in an upward direction is caused while contact is maintained and held in pressure with fabric surface 504. Similarly, in order to scroll in the opposite direction, down a list displayed on the portable computer, finger 901 is applied to the fabric surface 504 and then moved downward in the direction of arrow 903 while remaining in contact, and then removed.

In addition to the fabric keyboard 505, the case 401 may include a stylus 904 for operation of a portable computer. As shown, the fabric keyboard may include storage means for a stylus.

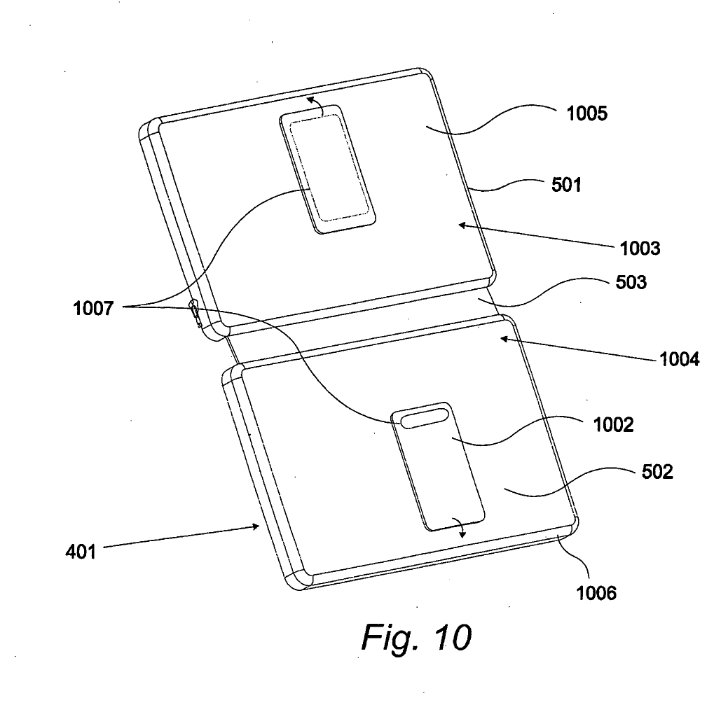

FIG. 10 is a rear view of case 401 in an open position. The case 401 includes first a first rigid flap 1001 and a second rigid flap 1002 that are each configured to be moveable to releasably engage with each other. The first and second rigid flaps 1001, 1002 are arranged to lie against the outer surface 1003, 1004 of the first and second parts 501, 502 respectively when not in use. Preferably, the first and first and second rigid flaps 1001, 1002 are arranged to lie flush against the outer surface 1003, 1004 of the first and second parts 501, 502 respectively when not in use.

The first rigid flap 1001 is pivotally attached to the first part 501 and is arranged to pivot outwards from the edge 1005 of the first rigid flap 1001 that is most distal from the hinge 503 of the case 401. Similarly, the second rigid flap 1002 is pivotally attached to the second part 502 and is arranged to pivot outwards from the edge 1006 of the second part 502 most distal from the hinge 503.

According to the arrangement shown in FIG. 10, the first and second rigid flaps 1001, 1002 are arranged to be releasably engaged by means of a hook and loop arrangement 1007, such as Velcro™. The hook component of such a mechanism is located upon one side of a first of the rigid flaps and the loop component is located on the opposite side of the second of the rigid flaps.

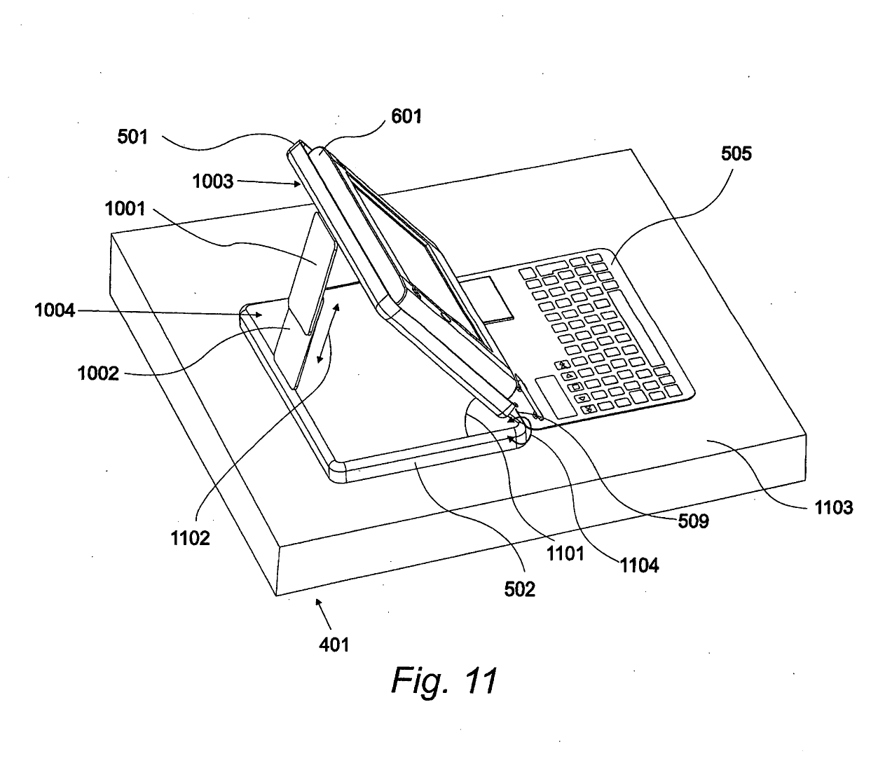

As illustrated in FIG. 11, the first and second rigid flaps 1001, 1002 are configured to releasably engage with each other to support the outer surface 1003 of the first part 501 of the case 401 at an acute angle, indicated at 1101, to the outer surface 1004 of the second part 502. As indicated by arrow 1102, the included angle may be varied by adjusting the overlap of the first and second rigid flaps 1001, 1002. The illustrated arrangement allows a ninety degree included angle between the two outer surfaces 1003, 1004 of the first and second parts 501, 502 to be maintained through engagement of the first and second rigid flaps 1001, 1002. The arrangement of the rigid flaps 1001, 1002 within the overall construction of the case 401 may allow a zero degree angle between the two outer surfaces 1003, 1004 of the first and second parts 501, 502 when the rigid flaps 1001, 1002 are not engaged with each other. Hence, the angle of incline of the first part relative to a support surface 1103 upon which the second part 502 is rested is variable.

This feature serves to enable a user to adjust the angle at which the portable computer 601 when held within the first part 501 of the case is viewed. In this example, the first part 501 of the case 401 may selectively be laid flat upon the second part 502, oriented perpendicular to the second part 502, or oriented at an angle in-between. In order to maintain the received portable computer 601 at an incline, securing means may be provided to secure the portable computer to the first part 501 of the case 401, for example, in the form of a hook-and-loop arrangement, among other suitable securing means, etc.

In order to present a data input interface when the case 401 is configured as shown in FIG. 11, the fabric keyboard 505 is rotatable about connected edge 509, as indicated by arrow 1104, to rest upon support surface 1103. In this position, fabric keyboard 505 and second part 502 extend substantially in the same plane along support surface 1103.

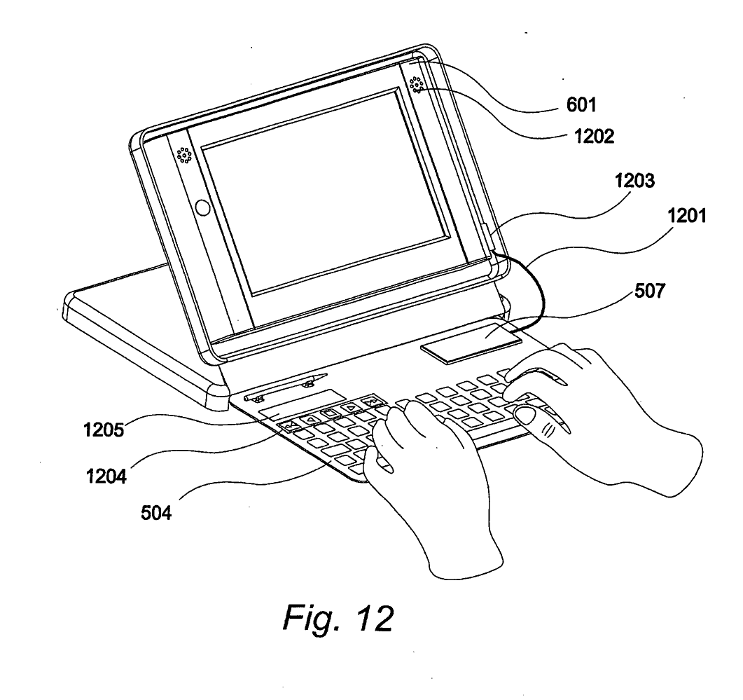

In the example of FIG. 12, output data is transmitted from the case 401 to the portable computer 601 by means of a mechanical interface. A USB connector cable 1201 is provided, which extends between the control circuit housing 507 of the case 401 and a USB port of the portable computer 601.

Portable computer 601 includes audio playback capability. In this example, the portable computer 601 is provided with speakers 1202 and an interface socket 1203 for stereo headphones, and is configured to provide an audio output signal to the speakers or an earpiece as selected by a user. Such an audio device may work using magnetic tape, magnetic discs, data discs, solid state storage devices, etc. Portable computer 601 includes the capability to produce an audio output signal from digital data files, including compressed audio data files, such as those identified by the designation MP3. In addition to alpha-numeric and symbolic keys for the operation of portable computer 601, fabric keyboard 505 includes audio control keys, indicated generally at 1204, for operation of the audio playback capability of the portable computer 601. Keys may be provided to control a variety of functions or aspects, for example play, stop, pause, fast forward, rewind, select, and mute.

The audio control keys, are responsive to manually applied pressure to control aspects of the audio playback capability of the portable computer when the portable computer is in the bag. As previously described, the fabric surface 504 is sensitive to manual presses and to manually applied gesticular movements.

In this example, manual presses are used to control discrete operations of the audio playback capability of the portable computer, such as play and stop, and gesticular movements are used to control variable operations of the audio playback capability of the portable computer, such as volume level control and tone control.

As illustrated in FIG. 12, an area 1205 responsive to gesticular movements that is separate to defined key regions may be defined on the fabric surface 504. In other applications, manual presses may control all controllable functions.

Cases as disclosed herein may conveniently provide both a protective covering for a portable computer and also apparatus and methods for supplying input data to the portable computer. By combining a case and manually operable data input device, a convenient solution is provided for the protected storage and transportation of a portable computer and also data input for the portable computer. In addition, the provision of a fabric keyboard does not add significant weight or bulk to the case. As disclosed herein, a case for a portable computer may be provided with a fabric keyboard that may be used when resting upon a part of the case or upon a support surface as selected.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. Apparatus for covering a portable computer, the apparatus comprising:
a case including:
a first part connected to a second part by an axial hinge allowing the first part and the second part to be configurable between an open position for receiving said portable computer and a closed position;
a fabric keyboard sensitive to the manual application of pressure and having defined key positions, and
a control circuit for identifying mechanical interactions to generate output data;
said case configured to enclose said portable computer and said fabric keyboard when in said closed position;
said fabric keyboard connected to said case such that the fabric keyboard may be turned about an axis within said case that extends substantially parallel to the axis of said hinge; and
said portable computer including an interface and executable instructions for interpreting said output data.

2. Apparatus according to claim 1, wherein said computer is of the type provided with a touch screen as an alternative to a keyboard.

3. Apparatus according to claim 1, wherein said computer is a tablet PC of the type that is smaller than a notebook PC but larger than a personal organizer.

4. Apparatus according to claim 1, wherein said first part and said second part each have a set shape.

5. Apparatus according to claim 4, wherein said first part and said second part are each molded from a plastic material.

6. Apparatus according to claim 4, wherein said first part and said second part are each rigid.

7. Apparatus according to claim 1, wherein said fabric surface is sensitive to manual presses and to gesticular movements.

8. Apparatus according to claim 1, wherein said control circuit is configured to detect the position of a mechanical interaction and the degree of applied pressure.

9. Apparatus according to claim 1, wherein said interface is a mechanical interface, such as a USB interface.

10. Apparatus according to claim 1, wherein said interface is a radio interface, such as a ZigBee interface.

11. Apparatus according to claim 1, wherein said hinge is a fabric hinge.

12. Apparatus according to claim 1, wherein said first part is provided with securing means to secure said portable computer to said first part.

13. Apparatus according to claim 1, wherein said first part has an outer surface, wherein said second part has an outer surface, wherein said case includes a first rigid flap and a second rigid flap, and wherein said first rigid flap and said second rigid flap are each configured to be moveable to releasably engage with each other to support the outer surface of said first part at an acute angle relative to the outer surface of said second part.

14. Apparatus according to claim 13, wherein said angle is adjustable.

15. Apparatus according to claim 1, wherein said case includes a zip fastener for securing said case in said closed position.

16. Apparatus according to claim 1, wherein said case includes stylus supporting means.
